(19) United States
(12) Patent Application Publication
(10) Pub. No.: US 2009/0136907 A1
(43) Pub. Date: May 28, 2009

(54) R.O.C. Syllable System

(76) Inventor: Robert Paul Baca, Phoenix, AR (US)

Correspondence Address: Robert Baca, 1324 E. Moreland, Phoenix, AZ, 85006, US

(21) Appl. No.: 11/382,291

(22) Filed: Nov. 28, 2007

(51) Int. Cl. G09B 19/06

(52) U.S. Cl. 434/157

(57) ABSTRACT

An English syllable system which uses English words, Partial English Words, and Phonics to teach people how to speak other languages with the accent as if the student were from that country. This system uses the preceding three types of words from the English Language to teach foreign languages.

### SPECIFICATIONS

This system uses English Words, Partial English Words and English Phonics. It is a process of using the preceding three types of words in a syllabicated system to help individuals pronounce words in foreign languages. Like the pronunciation of words in a dictionary, whereby you are able to pronounce the words using the system given in English dictionaries. This system uses the English sounding system to pronounce other languages.

An example of using this system is saying the word “sixteen,” in Spanish. You would put the following sounds together: use the sound of “dee,” from the word “deep;” then you would put the words “YES,” and “SEE,” together and then add the Phonic, “Sace,” which rhymes with “race.” Say the following sounds together as syllables: “dee-YES-SEE-Sacc.” When you say these sounds together like syllables you are saying the word, “sixteen in Spanish.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to using the English Language to teach different languages. The invention can be used to teach Spanish, French, Japanese, Chinese, Russian or any other language. Prior to this invention the phonetical systems used are mediocre at best and have variations of soundings to which one cannot perfect the accent of the language learned. You have to guess what the sounding is and this causes one to be embarrassed and to give up learning the language.

### BRIEF SUMMARY OF THE INVENTION

The general idea of this invention is to assist individuals in learning foreign languages with a system that they are familiar with, the English Language.

The advantage to using this invention is that the individual will be speaking another language as if he/she were a native of that country and with an the accent. And it is easy to learn because the individual will be using sounds from his/her own language to speak another language.

### BRIEF DESCRIPTION OF THE SEVERAL VIEWS OF THE DRAWING

FIG. 1 is how to say “my friend” in Spanish using English Words which are in all capital letters, and you just say the English Words together.

FIG. 2 is how to say “key” in Spanish using Partial English Words. The Partial English Words are in all lowercase letters and the complete English Word is above in brackets but you only pronounce the part of the word that is given.

FIG. 3 is how to say “glove” in Spanish using Partial English Words but the Partial English Word “the” is underlined so that the student will not make the mistake of saying the English Word “THE;”

FIG. 4 is how to say the word “three” in Spanish using Phonics, above the Phonic is a word that rhymes with the Phonic to assist the student to get the correct sounding, and in the Phonic, the first letter is capital and the rest of the word is in lowercase letters to differentiate the three different types of words;

FIG. 5 is how to say “sixteen” in Spanish using a combination of English Words, Partial English Words, and Phonics.

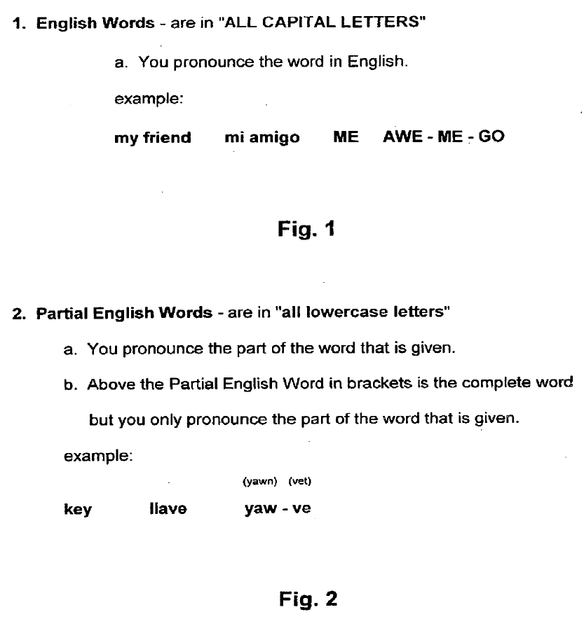

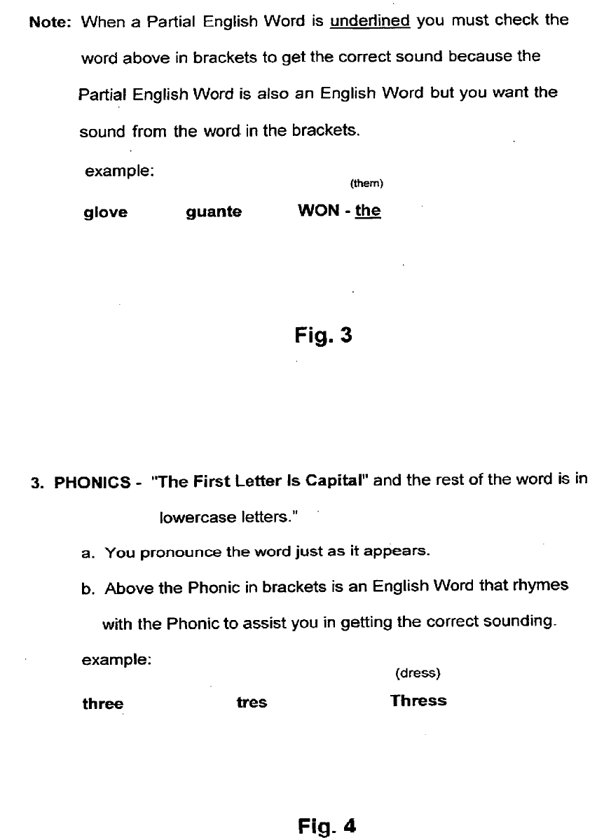

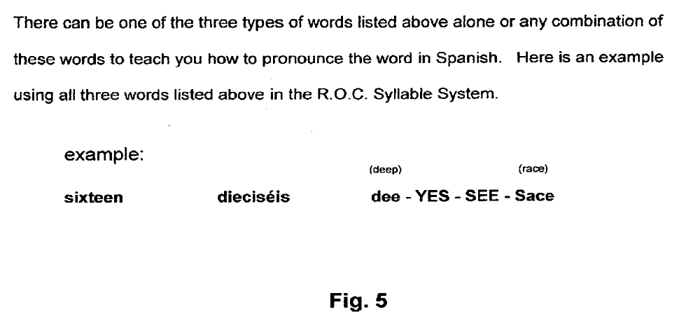

### DETAILED DESCRIPTION OF THE INVENTION

This system uses English Words, Partial English Words and English Phonics to teach individuals how to speak different languages. It is a process of using the preceding three types of words in a syllabicated system to help individuals pronounce words in foreign languages. Like the pronunciation of words in a dictionary, whereby you are able to pronounce the words using the system given in English dictionaries. This system uses the English sounding system to pronounce other languages.

English Words are in “ALL CAPITAL LETTERS,” and you pronounce the word as an English Word.

Partial English Words are in “all lowercase letters,” and you pronounce the part of the word that is given. Above the Partial English Word in brackets is the complete word but you only pronounce the part of the word that is given.

When a Partial English Word is underlined you must check the word above in brackets to get the correct sound because the Partial English Word is also an English Word but you want the sound from the word in the brackets.

Phonics have the “First Letter Capital,” and the rest of the word is in lowercase letters. You pronounce the word just as it appears and above the phonic in brackets is an English Word that rhymes with the phonic to assist the individual in getting the correct sounding.

Another example of using this system is saying the word “sixteen,” in Spanish. You would put the following sounds together: use the sound of “dee,” from the word “deep,” then you would put the words “YES.” and “SEE,” together and then add the Phonic, “Sace,” which rhymes with “race.” Say the following sounds together as syllables: “dec-YES-SEE-Sace-” When you say these sounds together like syllable you are saying the word, “sixteen in Spanish.

There are various combinations of English Words, Partial English Words, and Phonics to teach people how to speak foreign languages. This invention teaches you how to speak another language with the accent of the foreign language.

What distinguishes this invention from previous methods, systems, or techniques is the use of English Words and Partial English Words. The only other system that is available is the use of only phonetics.

1. I Robert Baca, claim the R.O.C. Syllable System using English Words, Partial English Words, and Phonics to teach people how to speak different languages.
